(19) United States
(12) Patent Application Publication
(10) Pub. No.: US 2011/0231092 A1
(43) Pub. Date: Sep. 22, 2011

(54) REAL-TIME TRACKING OF DIGITAL CAMERAS AND WIRELESS CAPABLE DEVICES

(75) Inventors: Hanchang Kuo, Fremont, CA (US); Hans Masli, Milpitas, CA (US)

(73) Assignee: SONY CORPORATION, Tokyo (JP)

(21) Appl. No.: 12/727,083

(22) Filed: Mar. 18, 2010

(51) Int. Cl. G01S 3/02; H04L 9/00; G06F 17/30; G06F 3/048; G01C 21/00

(52) U.S. Cl. 701/208; 713/150; 707/752; 715/764; 342/451; 707/802; 707/E17.005

(57) ABSTRACT

A portable device such as a camera comprises a wireless tracking unit for tracking the position of the portable device utilizing wireless internet technologies. When enabled, the portable device automatically determines its global position and uploads the position to a tracking server where the position data is saved in a position database. The position data is able to then be accessed at any time by a specified group comprising the user and any specified friends or family of the user upon accessing the tracker server from a personal computer or their portable devices. As a result, members of the specified group are able to track each other's real-time locations and history of locations throughout the world.

### FIELD OF THE INVENTION

The present invention relates to the field of wireless tracking. More specifically, the present invention relates to the real-time tracking of digital cameras and wireless capable devices.

### BACKGROUND OF THE INVENTION

The field of wireless tracking is becoming increasingly popular as new tracking methods and devices arise that allow the user to keep track of the positions of friends and family. However, these methods are often bulky and expensive. As a result, they do not translate well on devices that need to be small such as phones and cameras, as well as significantly increasing the cost or being cost prohibitive. Additionally, in order to utilize many of these methods it is required that the user subscribe to an expensive 3G service. Furthermore, these services do not work outside of the coverage area or in foreign countries.

### SUMMARY OF THE INVENTION

A portable device such as a camera comprises a wireless tracking unit for tracking the position of the portable device. When enabled, the portable device automatically determines its global position and uploads the position to a tracking server when in communication with a wireless network, where the position data is saved in a position database. The position data is able to then be accessed at any time by a specified group comprising the user and any specified friends or family of the user upon accessing the tracker server from a personal computer or other portable devices. Thus, the portable device is able to keep track of the time and location of certain events such as when and where a picture was taken. As a result, members of the specified group are able to track each other's real-time locations and history of locations throughout the world.

In one aspect, the present application relates to a system for tracking the location of a portable device. The system comprises a portable device having a tracker unit, wherein the tracker unit periodically determines and stores location and identification data of the portable device and a tracker server having a user database, wherein the location and identification data is automatically sent from the portable device to the tracker server when the portable device is in communication with a wireless network and the tracker server stores the location and identification data in the user database, wherein the portable device is in communication with the tracker server via the wireless network. In some embodiments, the portable device is a camera. In some embodiments, the location and identification data is encrypted to prevent unauthorized access to the data. In some embodiments, the wireless network comprises one or more WiFi, subscription based or cellular networks. In some embodiments, the tracker server sorts the location data in the user database based on the identification data. In some embodiments, the portable device further comprises a tracking disable feature that allows the user to prevent the portable device from sending the location data to the tracking server. In some embodiments, the location data comprises one or more sets of a longitude, a latitude and a time. In some embodiments, the portable device is configured to send image data to the tracker server wherein the tracker server stores the image data in the user database based on the identification data. In some embodiments, the portable device further comprises a display, and wherein the tracker unit displays the location data on the display by indicating one or more positions of the portable device on a map. In some embodiments, the tracker unit further displays links to the image data on the display such that the image data is able to be displayed on the display by following the links. The system further comprises a user profile database, wherein a user registers user profile information with the tracker server and the tracker server stores the user profile information in the user database based on the identification data. In some embodiments, the user profile information comprises any combination of a username, a password, a group list and avatar data. In some embodiments, the group list comprises one or more pre-registered subscribers, wherein the subscribers access the tracker server through one or more wireless capable devices.

In another aspect, the present application relates to a portable device. The portable device comprises a tracker unit, wherein the tracker unit periodically determines and stores location and identity data of the portable device, wherein the portable device is configured to communicate with a tracker server having a user database via a wireless network, and further wherein the location and identification data is automatically sent from the portable device to the tracker server when the portable device is in communication with the wireless network, wherein the tracker server stores the location and identification data in the user database. In some embodiments, the portable device further comprises a tracking disable feature that allows the user to prevent the portable device from sending the location data to the tracking server. In some embodiments, the location and identification data is encrypted to prevent unauthorized access to the data. In some embodiments, the wireless network comprises one or more WiFi, subscription based or cellular networks. In some embodiments, the tracker server sorts the location data in the user database based on the identification data. In some embodiments, the portable device is a camera. In some embodiments, the location data comprises one or more sets of a longitude, a latitude and a time. The portable device is configured to send image data to the tracker server wherein the tracker server stores the image data in the user database based on the identification data. The portable device further comprises a display, and wherein the tracker unit displays the location data on the display by indicating one or more positions of the portable device on a map. The tracker unit further displays links to the image data on the display such that the image data is able to be displayed on the display by following the links. The portable device further comprises a user profile database, wherein a user registers user profile information with the tracker server and the tracker server stores the user profile information in the user database based on the identification data. In some embodiments, the user profile information comprises any combination of a username, a password, a group list and avatar data. In some embodiments, the group list comprises one or more pre-registered subscribers, wherein the subscribers access the tracker server through one or more wireless capable devices.

Yet another aspect of the present application is directed to a method of wirelessly tracking a portable device. The method comprises periodically determining and storing location and identification data of a portable device having a tracker unit with the tracker unit and automatically sending the location and identification data to a tracker server having a user database when the portable device is in communication with a wireless network, wherein the tracker server stores the location data in the user database. In some embodiments, the portable device is a camera. The portable device further comprises a tracking disable feature that allows the user to prevent the portable device from sending the location data to the tracking server. In some embodiments, the location and identification data is encrypted to prevent unauthorized access to the data. In some embodiments, the tracker server sorts the location data in the user database based on the identification data. In some embodiments, the wireless network comprises one or more WiFi, subscription based or cellular networks. In some embodiments, the location data comprises one or more sets of a longitude, a latitude and a time. The method further comprises sending image data from the portable device to the tracker server wherein the tracker server stores the image data in the user database based on the identification data. In some embodiments, the portable device further comprises a display, and the method further comprises displaying the location data on the display by indicating one or more positions of the portable device on a map. The method further comprises displaying links to the image data on the display such that the image data is able to be displayed on the display by following the links. The method further comprises registering user profile information with the tracker server and the tracker server storing the user profile information in the user database based on the identification data. In some embodiments, the user profile information comprises any combination of a username, a password, a group list and avatar data. In some embodiments, the group list comprises one or more pre-registered subscribers, wherein the subscribers access the tracker server through one or more wireless capable devices.

Another aspect of the present application is directed to a tracker server. The tracker server comprises a user database, wherein the tracker server is configured to communicate with a portable device having a tracker unit, wherein the tracker unit periodically determines and stores location and identification data of the portable device, and further wherein the location and identification data is automatically sent from the portable device to the tracker server when the portable device is in communication with a wireless network and the tracker server stores the location and identification data in the user database, wherein the portable device is in communication with the tracker server via the wireless network. In some embodiments, the portable device is a camera. The portable device further comprises a tracking disable feature that allows the user to prevent the portable device from sending the location data to the tracking server. In some embodiments, the location and identification data is encrypted to prevent unauthorized access to the data. In some embodiments, the wireless network comprises one or more WiFi, subscription based or cellular networks. In some embodiments, the tracker server sorts the location data in the user database based on the identification data. In some embodiments, the location data comprises one or more sets of a longitude, a latitude and a time. In some embodiments, the portable device is configured to send image data to the tracker server wherein the tracker server stores the image data in the user database based on the identification data. The portable device further comprises a display, and wherein the tracker unit displays the location data on the display by indicating one or more positions of the portable device on a map. In some embodiments, the tracker unit further displays links to the image data on the display such that the image data is able to be displayed on the display by following the links. The server further comprises a user profile database, wherein a user registers user profile information with the tracker server and the tracker server stores the user profile information in the user database based on the identification data. In some embodiments, the user profile information comprises any combination of a username, a password, a group list and avatar data. In some embodiments, the group list comprises one or more pre-registered subscribers, wherein the subscribers access the tracker server through one or more wireless capable devices.

### BRIEF DESCRIPTION OF THE DRAWINGS

FIG. 1 illustrates an exemplary real-time tracking system according to some embodiments.

FIG. 2 illustrates a back view of an exemplary portable device according to some embodiments.

FIG. 3 illustrates an exemplary display of location data on a map according to some embodiments.

FIG. 4 illustrates an exemplary storage method for identification, location and image data in a user database according to some embodiments.

FIG. 5 illustrates a flowchart of a method of utilizing a personal library according to some embodiments.

### DETAILED DESCRIPTION OF THE PREFERRED EMBODIMENT

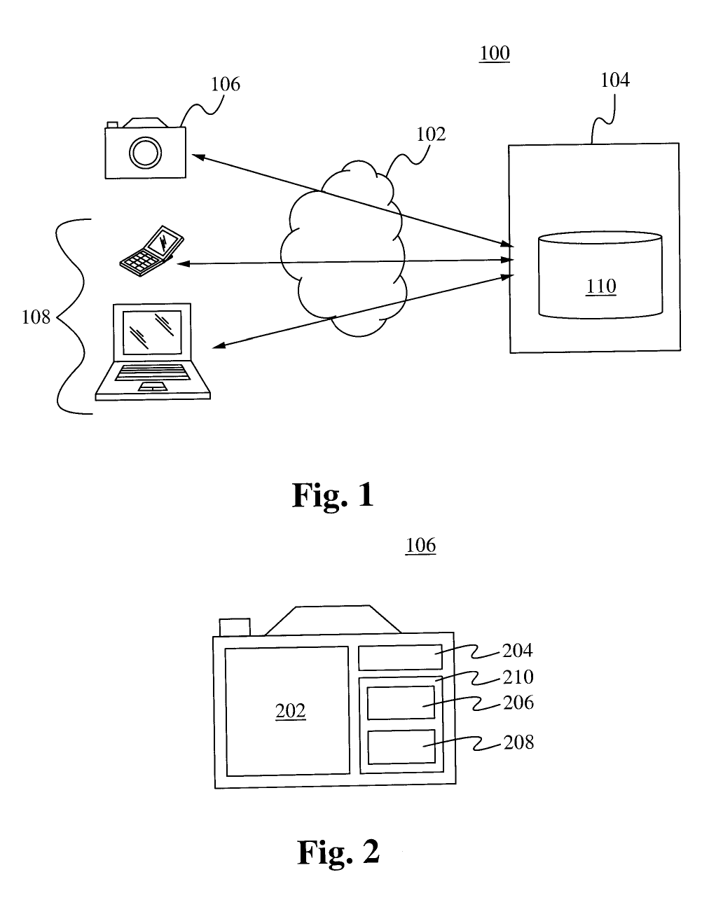

FIG. 1 illustrates a system 100 for tracking the location of a portable device 106 such as a camera in accordance with some embodiments. In some embodiments, the system 100 comprises a camera 106 and a tracker server 104 having a user database 110 in communication with each other through a wireless network 102. Alternatively, the system 100 comprises any other wireless capable devices 106, 108 in communication with the tracker server 104 through the wireless network 102. The wireless network 102 comprises any number of Wi-Fi or subscription based wireless access points (not shown). Alternatively, a cellular network 102 (e.g. 3G network) is used to couple the camera 106 to the tracker server 104. Alternatively, the network 102 comprises the combination of any number of Wi-Fi or subscription based wireless access points and a cellular network. In some embodiments, the system 100 further comprises one or more wireless capable devices 108 in communication with the tracker server 104 by the wireless network 102 selected from a group including but not limited to personal computers, cameras, and cellular phones. In some embodiments, the system 100 comprises one or more wireless or cellular networks that are in communication with the camera 106 and the tracker server 104.

As shown in FIG. 2, the camera 106 comprises a display 202, a disable feature 204, and a tracker unit 210. The tracker unit 210 comprises a location engine 206 and a location application 208. Alternatively, the tracker unit 210 only comprises a location engine 206. In some embodiments, the camera 106 is a digital still camera (DSC). Alternatively, the camera 106 is any type of camera. The location engine 206 is in communication with the network 102 through the camera 106 and periodically determines the current location of the camera 106. Specifically, the location engine 206 periodically acquires the current longitude and latitude of the camera 106 and stores the location as location data. The location data is acquired through any combination of GPS, wireless internet networks, and/or wireless cellular networks. Alternatively, any other means of wireless tracking is able to be used. The period at which the location engine 206 acquires the location data is able to be adjusted based on the needs of the user. In some embodiments, the location data comprises the time at which the current location data was acquired. Alternatively, the location data may comprise any other location related data. The location engine 206 also acquires identification data from the camera 106 in order to uniquely identify the camera 106 and the associated location data. In some embodiments, this identification data comprises a unique identification number associated with the camera 106. Alternatively, the identification data is able to comprise any other identification means that identifies the camera 106.

The location application 208 is in communication with the network 102 and the location engine 206 such that the location application 208 is able to access the identification and location data from the location engine 206 after the data is acquired. In some embodiments, the location application 208 is Google Earth™. Alternatively, the location application 208 is any other suitable application including but not limited to Microsoft Virtual Earth™, Facebook™, or Myspace™. After acquiring the location data and when in communication with the wireless network 102, the location application 208 automatically transmits the identification and location data to the tracker server 104, which stores the data in a user database 110 as described in detail below. Alternatively, the location application 208 transmits the data upon request by a user. If the location application 208 is unable to connect to the wireless network 102, the location application 208 continues to periodically attempt to do so until the connection to the wireless network 102 is restored. During the time that the location application 208 is unable to connect to the wireless network 102, the location engine 206 continues to determine and store location data as described above, such that when the connection to the wireless network 102 is restored, an entire log of location data that was stored during the disconnected period is transmitted to the tracker server 104 and stored in the user database 110. Alternatively, only a portion of the stored location data is transmitted. The location application 208 is further configured to access image data (e.g. pictures, video, etc. . . . ) from the camera 106 and to upload that image data to the tracker server 104. In some embodiments, the application 208 uploads the image data automatically when in communication with the wireless network 102. Alternatively, the location application 208 uploads the image data upon request by a user. In some embodiments, the identification, location and or image data is encrypted such that unauthorized access to the data is prevented. Alternatively, other data protection means are utilized such as secure internet connections and other methods well known in the art. In some embodiments, the location application 208 sends location and or image data requests to the tracker server 104. Specifically, at the direction of a user, the location application 208 sends a request for the position and or image data of the camera 106. Alternatively, the location application 208 periodically automatically requests for the position or image data of the camera 106. The tracker server 104 subsequently responds to the location application's request with the requested location and or image data stored in the user database 110 based on the user profile as described in detail below.

The display 202 is in communication with the location application 208 such that the display 202 is able to receive position and image data from the location application 208. In some embodiments, the display 202 is a liquid crystal display (LCD). Alternatively, any other suitable display is able to be used as is well known in the art. In particular, the display 202 receives the position and image data sent by the tracker server 104 in response to the location application 208 requests and then displays the data for the user. Specifically, the display 202 displays the real-time current position of the camera 106 on a map 300 generated by the location application 208 based on the position data received from the tracker server 104. In some embodiments, at the direction of the user, the display 202 displays not only the real-time current position of the camera 106, but also a set of previously stored positions on the map 300, simultaneously. By doing so, the user is able to see a “path graph” which illustrates the path which the camera 106 has taken through the map 300. The user is also able to select how far back in time they wish to be displayed by the path. This is especially convenient in that the “path graph” allows the user to trace back their path with the camera 106 for use in travel journals or blogs.

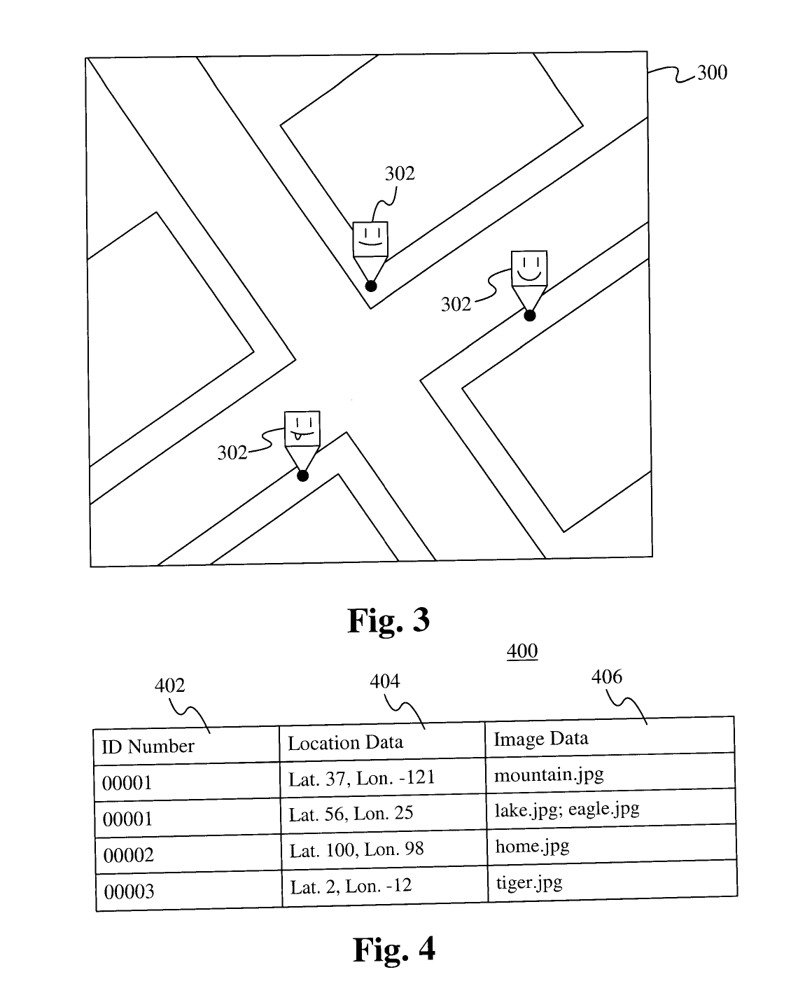

As shown in FIG. 3, the display of the camera's current position is able to be shown with a marker and picture displaying the user's avatar 302. Alternatively, the camera's current position is able to be represented by any reasonable means known in the art. Similarly, the “path graph” is able to be displayed as a line chronologically connecting the positions of the camera 106. Alternatively, the “path graph” is able to be displayed in any other suitable manner including but not limited to a set of current and former positions numbered chronologically. In some embodiments, the display 202 includes an update interval that is able to be adjusted by the user, wherein the update interval periodically causes the location application 208 to request and obtain new position and image data from the tracker server 104 and to update the display 202 with the new data. Alternatively, the location application 208 automatically updates the display 202 whenever new location and or image data is acquired by the tracker server 104.

With regard to image data, the display 202 is able to display links on the map 300 to any image data received from the tracker server 104 such that the user is able to follow the links and see the content of the image data on the display 202. Alternatively, the image data is able to be displayed in any other suitable manner that illustrates the content of the image data. Moreover, in the same manner as with the camera's location and image data, the display 202 is able to receive the position and image data of one or more other wireless capable devices 108 as described below. Specifically, the location and image data of the other devices 108 is sent by the tracker server 104 in response to the location application 208 requests and then displayed as described above on the display 202 for the user. Therefore, the display 202 displays the real-time current position of not only the camera 106, but all of the one or more devices 108 on a map 300 generated by the location application 208 based on the position data received from the tracker server 104. In this manner, a user is able to keep track of the positions of their friends and share image data with them in real time.

The disable feature 204 is in communication with the location application 208 and is configured such that when the user activates the disable feature 204, the location application 208 is prohibited from transmitting location, identification or image data to the tracker server 104. Thus, if the user does not want the positions and images of the camera 106 to be tracked for privacy reasons, the user's desire is able to be easily effectuated. Further, the tracking is able to be enabled again by the user at any time by deactivating the disable feature 204. Alternatively, the disable feature 204 is in communication with the tracker server 104 and thus the user is able to activate the disable feature 204 whenever they are in contact with the tracker server 104.

As shown in FIG. 1, the tracker server 104 communicates with the camera 106 and one or more wireless capable devices 108 through the wireless network 102. The tracker server 104 comprises a user database 110 and is configured to receive identification, location and image data from the camera 106 or the wireless capable devices 108. Upon receipt of the data, the tracker server 104 stores the data in the user database 110 based on the identification data. In other words, the location and image data is indexed by the identification data such that all the location and image data associated with a particular set of identification data is able to be distinguished from location and image data associated with any other identification data. In some embodiments, the data is further organized in the user database 110 chronologically based on time stamps included in the location data. Alternatively, the data is organized in any suitable manner that allows the data to be sorted based on the associated identification data. Further, in some embodiments, one or more portions of the image data are associated with one or more portions of the location data such that the image data is able to be sorted by location. As shown in FIG. 4, an exemplary organization of the identification, location and image data is illustrated in a table 400 wherein the each location 404 of the location data is associated with a particular identification number 402 of the identification data and a particular image or images 406 of the image data. Thus, if the tracker server 104 wishes to access all the data associated with a particular identification number, the tracker server 104 is able to sort the data in the user database 110 by that identification number 402 and retrieve the associated location data 404 and image data 406.

In some embodiments, the tracker server 104 receives location and image data requests from the camera 106 or other wireless devices 108 and transmits corresponding data back if the requesting camera or wireless device log is registered with the tracker server 104. In some embodiments, to register a device 108, the user of a device 108 must access the tracker server 104 and create a user profile that includes a username, password, avatar data (e.g. avatar image 302), device identification data and a list of other registered user profiles that the user wishes to be included in their subscriber group. Thus, the user profile establishes an initial user/device identification data set in the user database 110 which is able to then be used to sort any future identification, location and image data received. Further, with the subscriber group, the user profile establishes security/accessibility settings for the user's location and image data such that only the registered user profiles included in the subscriber group are permitted to access the user's location and image data through the tracker server 104. The user is able to update the subscriber group at any time to add or subtract from the registered user profiles included. Accordingly, this allows an individual to specify a group of friends that have access to the individual's location and image data and therefore is able to track the individual's position on the friends' wireless capable devices 108. In some embodiments, the user profile alternatively comprises any other data suitable for creating and storing identification, access and security settings. Once the camera 106 or other wireless devices 108 are registered, the tracker server 104 responds to the camera 106 or other wireless devices' 108 data requests by transmitting all the requested data associated with the camera 106 or other wireless devices' 108 identification number, including any requested data associated with the other user profiles wherein the camera 106 or other wireless devices' 108 identification number is included in the other user profiles' subscriber group. Accordingly, the data transmitted by the tracker server 104 is able to be received by the camera 106 or other wireless devices 108 and displayed on the camera 106 or other wireless devices' 108 displays 202 as described above.

The one or more wireless capable devices 108 as shown in FIG. 1, comprise a display 202 and a location application 208 and are in communication with the tracker server 104 through the wireless network 102. In some embodiments, the wireless devices 108 comprise any combination of a cell phone, a personal computer, or a camera 106. Alternatively, the devices 108 comprise any other wireless capable device. In some embodiments, a number of the wireless devices 108 also comprise a location engine 206 which operates in the same manner as described above in relation to the camera 106. In some embodiments, the devices 108 comprise a disable feature 204 that operates in the same manner as described above in reference to the camera 106. Alternatively, the devices 108 do not comprise a disable feature 204 and or a location engine 206. The wireless devices 108 are registered with the tracker server 104, as described above, and are thereby configured to receive location and image data from the tracker server 104. Specifically, in a similar manner as the camera 106 as discussed above, the devices 108 send data requests to the tracker server 104 and the tracker server 104 responds with the relevant image and location data based on the devices' user profiles. Thus, if the user profile of the device 108 is listed on a subscriber group list of another user profile, the other user's image and location data will be transmitted to the device 108 and displayed in the same manner as described above in relation to the camera 106. Further, if the device 108 comprises a location engine 206, the tracker server 104 will also transmit the location and image data associated with that device 108. Accordingly, the users of these one or more wireless capable devices 108 are able to track the real-time location and images of the other users wherein the other users belong to the other user's subscriber group. Indeed, this allows friends and family to keep real-time track of each other's position and share each other's images.

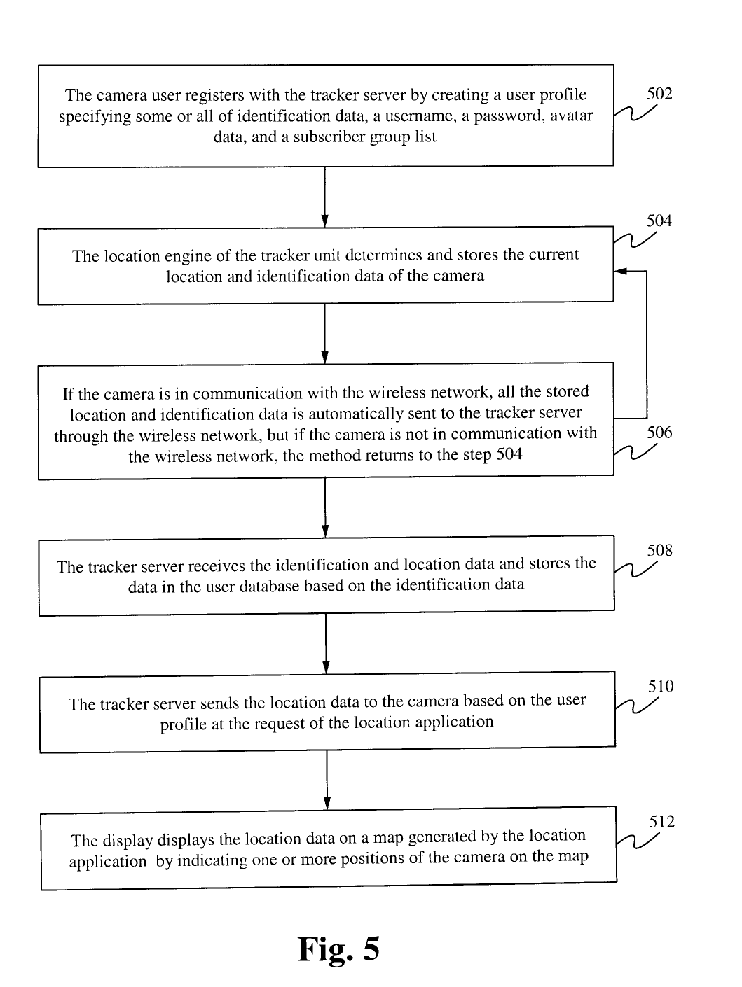

The operation of the real-time tracking of digital cameras and wireless capable devices 108 will now be discussed in conjunction with a flow chart illustrated in FIG. 5. In operation, as shown in FIG. 1, the camera 106 user registers with the tracker server 104 by creating a user profile specifying some or all of identification data, a username, a password, avatar data, and a subscriber group list at the step 502. In some embodiments, the users of one or more other wireless capable devices 108 register with the tracker server 104. The location engine 206 of the tracker unit 210 determines and stores the current location and identification data of the camera 106 at the step 504. In some embodiments, one or more of the wireless capable devices 108 comprise a tracker unit 210 that determines and stores the one or more wireless capable devices' 108 location and identification data. If the camera 106 is in communication with the wireless network 102, all the stored location and identification data is automatically sent to the tracker server 104 through the wireless network 102, but if the camera 106 is not in communication with the wireless network 102, the method returns to the step 504 at the step 506. In some embodiments, the stored location and identification data is automatically sent by the location application 208. In some embodiments, if the one or more wireless capable devices 108 are in communication with the wireless network 102, the identification, location and or image data of the one or more wireless capable devices 108 is automatically sent to the tracker server 104. In some embodiments, if the one or more wireless capable devices 108 are not in communication with the wireless network 102, the method returns to the step 504. In some embodiments, the image data is automatically sent from the camera 106 to the tracker server 104. In some embodiments, the image data is automatically sent by the location application 208 of the camera 106. The tracker server 104 receives the identification and location data and stores the data in the user database 110 based on the identification data at the step 508. In some embodiments, the tracker server 104 also receives the image data and stores the image data in the user database 110 based on the identification data. In some embodiments, the tracker server 104 receives location and or image data from one or more of the other wireless devices 108 and stores the data in the user database 110 based on the wireless devices' 108 user profiles. The tracker server 104 sends the location data to the camera 106 based on the user profile at the request of the location application 208 at the step 510. In some embodiments, the tracker server 104 also sends the image data to the camera 106 based on the user profile at the request of the location application 208. In some embodiments, the camera 106 and other wireless devices 108 receive each other's location and or image data based on their user profile from the tracker server 104 based on their user profile. The display 202 displays the location data on a map 300 generated by the location application 208 by indicating one or more positions of the camera 106 on the map 300 at the step 512. In some embodiments, the display 202 also displays the image data on the map 300 by displaying links to the image data content wherein the image data content is displayed on the display 202 by following the links. In some embodiments, the camera 106 and other wireless devices 108 display each other's location and or image data on a map 300 generated by the camera 106 or other wireless devices' 108 location applications 208 on the camera 106 or other wireless devices' 108 displays 202. In some embodiments, the operation further comprises deactivating the disable feature 204 on the camera 106 and other wireless devices 108. In some embodiments, the user and friends are able to access the tracker server 104 from the camera or one or more wireless capable devices 108 through the wireless network 102.

The method, system and apparatus for the real-time tracking of a camera and other wireless capable devices described herein has numerous advantages. Specifically, the real-time tracking allows friends and families to share the same excitement of any wireless device user as if they were on the trip. They are able to share images as well as keep track of their friends and family's positions, even creating a “path graph” to track the path of the device user. Further, unlike other real-time tracking systems, the present application allows for essentially worldwide coverage wherever there is a wireless network regardless if the network is subscriber based or a free hotspot.

### Embodiments of Real Time Tracking

1. A system for tracking the location of a portable device comprising:

a portable device having a tracker unit, wherein the tracker unit periodically determines and stores location and identification data of the portable device; and

a tracker server having a user database, wherein the location and identification data is automatically sent from the portable device to the tracker server when the portable device is in communication with a wireless network and the tracker server stores the location and identification data in the user database;

wherein the portable device is in communication with the tracker server via the wireless network.
2. The system of clause 1 wherein the portable device is a camera.
3. The system of clause 1 wherein the location and identification data is encrypted to prevent unauthorized access to the data.
4. The system of clause 1 wherein the wireless network comprises one or more WiFi, subscription based or cellular networks.
5. The system of clause 1 wherein the tracker server sorts the location data in the user database based on the identification data.
6. The system of clause 1 wherein the portable device further comprises a tracking disable feature that allows the user to prevent the portable device from sending the location data to the tracking server.
7. The system of clause 1 wherein the location data comprises one or more sets of a longitude, a latitude and a time.
8. The system of clause 7 wherein the portable device is configured to send image data to the tracker server wherein the tracker server stores the image data in the user database based on the identification data.
9. The system of clause 8 wherein the portable device further comprises a display, and wherein the tracker unit displays the location data on the display by indicating one or more positions of the portable device on a map.
10. The system of clause 9 wherein the tracker unit further displays links to the image data on the display such that the image data is able to be displayed on the display by following the links.
11. The system of clause 10 further comprising a user profile database, wherein a user registers user profile information with the tracker server and the tracker server stores the user profile information in the user database based on the identification data.
12. The system of clause 11 wherein the user profile information comprises any combination of a username, a password, a group list and avatar data.
13. The system of clause 12 wherein the group list comprises one or more pre-registered subscribers, wherein the subscribers access the tracker server through one or more wireless capable devices.
14. A portable device comprising:

a tracker unit, wherein the tracker unit periodically determines and stores location and identity data of the portable device, wherein the portable device is configured to communicate with a tracker server having a user database via a wireless network, and further wherein the location and identification data is automatically sent from the portable device to the tracker server when the portable device is in communication with the wireless network, wherein the tracker server stores the location and identification data in the user database.
15. The device of clause 14 wherein the portable device further comprises a tracking disable feature that allows the user to prevent the portable device from sending the location data to the tracking server.
16. The device of clause 14 wherein the location and identification data is encrypted to prevent unauthorized access to the data.
17. The device of clause 14 wherein the wireless network comprises one or more WiFi, subscription based or cellular networks.
18. The device of clause 14 wherein the tracker server sorts the location data in the user database based on the identification data.
19. The device of clause 14 wherein the portable device is a camera.
20. The device of clause 14 wherein the location data comprises one or more sets of a longitude, a latitude and a time.
21. The device of clause 20 wherein the portable device is configured to send image data to the tracker server wherein the tracker server stores the image data in the user database based on the identification data.
22. The device of clause 21 wherein the portable device further comprises a display, and wherein the tracker unit displays the location data on the display by indicating one or more positions of the portable device on a map.
23. The device of clause 22 wherein the tracker unit further displays links to the image data on the display such that the image data is able to be displayed on the display by following the links.
24. The device of clause 23 further comprising a user profile database, wherein a user registers user profile information with the tracker server and the tracker server stores the user profile information in the user database based on the identification data.
25. The device of clause 24 wherein the user profile information comprises any combination of a username, a password, a group list and avatar data.
26. The device of clause 25 wherein the group list comprises one or more pre-registered subscribers, wherein the subscribers access the tracker server through one or more wireless capable devices.
27. A method of wirelessly tracking a portable device comprising:

periodically determining and storing location and identification data of a portable device having a tracker unit with the tracker unit; and

automatically sending the location and identification data to a tracker server having a user database when the portable device is in communication with a wireless network, wherein the tracker server stores the location data in the user database.
28. The method of clause 27 wherein the portable device is a camera.
29. The method of clause 27 wherein the portable device further comprises a tracking disable feature that allows the user to prevent the portable device from sending the location data to the tracking server.
30. The method of clause 27 wherein the location and identification data is encrypted to prevent unauthorized access to the data.
31. The method of clause 27 wherein the tracker server sorts the location data in the user database based on the identification data.
32. The method of clause 27 the wireless network comprises one or more WiFi, subscription based or cellular networks.
33. The method of clause 27 wherein the location data comprises one or more sets of a longitude, a latitude and a time.
34. The method of clause 33 further comprising sending image data from the portable device to the tracker server wherein the tracker server stores the image data in the user database based on the identification data.
35. The method of clause 34 wherein the portable device further comprises a display, and the method further comprises displaying the location data on the display by indicating one or more positions of the portable device on a map.
36. The method of clause 35 further comprising displaying links to the image data on the display such that the image data is able to be displayed on the display by following the links.
37. The method of clause 36 further comprising registering user profile information with the tracker server and the tracker server storing the user profile information in the user database based on the identification data.
38. The method of clause 37 wherein the user profile information comprises any combination of a username, a password, a group list and avatar data.
39. The method of clause 38 wherein the group list comprises one or more pre-registered subscribers, wherein the subscribers access the tracker server through one or more wireless capable devices.
40. A tracker server comprising:

a user database, wherein the tracker server is configured to communicate with a portable device having a tracker unit, wherein the tracker unit periodically determines and stores location and identification data of the portable device, and further wherein the location and identification data is automatically sent from the portable device to the tracker server when the portable device is in communication with a wireless network and the tracker server stores the location and identification data in the user database, wherein the portable device is in communication with the tracker server via the wireless network.
41. The server of clause 40 wherein the portable device is a camera.
42. The server of clause 40 wherein the portable device further comprises a tracking disable feature that allows the user to prevent the portable device from sending the location data to the tracking server.
43. The server of clause 40 wherein the location and identification data is encrypted to prevent unauthorized access to the data.
44. The server of clause 40 wherein the wireless network comprises one or more WiFi, subscription based or cellular networks.
45. The server of clause 40 wherein the tracker server sorts the location data in the user database based on the identification data.
46. The server of clause 40 wherein the location data comprises one or more sets of a longitude, a latitude and a time.
47. The server of clause 46 wherein the portable device is configured to send image data to the tracker server wherein the tracker server stores the image data in the user database based on the identification data.
48. The server of clause 47 wherein the portable device further comprises a display, and wherein the tracker unit displays the location data on the display by indicating one or more positions of the portable device on a map.
49. The server of clause 48 wherein the tracker unit further displays links to the image data on the display such that the image data is able to be displayed on the display by following the links.
50. The server of clause 49 further comprising a user profile database, wherein a user registers user profile information with the tracker server and the tracker server stores the user profile information in the user database based on the identification data.
51. The server of clause 50 wherein the user profile information comprises any combination of a username, a password, a group list and avatar data.
52. The server of clause 51 wherein the group list comprises one or more pre-registered subscribers, wherein the subscribers access the tracker server through one or more wireless capable devices.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Particularly, the real-time tracking of a camera described herein is able to be extended to any wireless capable device.

What is claimed is:

1. A system for tracking the location of a portable device comprising:
a portable device having a tracker unit, wherein the tracker unit periodically determines and stores location and identification data of the portable device; and
a tracker server having a user database, wherein the location and identification data is automatically sent from the portable device to the tracker server when the portable device is in communication with a wireless network and the tracker server stores the location and identification data in the user database;
wherein the portable device is in communication with the tracker server via the wireless network.

2. The system of claim 1 wherein the portable device is a camera.

3. The system of claim 1 wherein the location and identification data is encrypted to prevent unauthorized access to the data.

4. The system of claim 1 wherein the wireless network comprises one or more WiFi, subscription based or cellular networks.

5. The system of claim 1 wherein the tracker server sorts the location data in the user database based on the identification data.

6. The system of claim 1 wherein the portable device further comprises a tracking disable feature that allows the user to prevent the portable device from sending the location data to the tracking server.

7. The system of claim 1 wherein the location data comprises one or more sets of a longitude, a latitude and a time.

8. The system of claim 7 wherein the portable device is configured to send image data to the tracker server wherein the tracker server stores the image data in the user database based on the identification data.

9. The system of claim 8 wherein the portable device further comprises a display, and wherein the tracker unit displays the location data on the display by indicating one or more positions of the portable device on a map.

10. The system of claim 9 wherein the tracker unit further displays links to the image data on the display such that the image data is able to be displayed on the display by following the links.

11. The system of claim 10 further comprising a user profile database, wherein a user registers user profile information with the tracker server and the tracker server stores the user profile information in the user database based on the identification data.

12. The system of claim 11 wherein the user profile information comprises any combination of a username, a password, a group list and avatar data.

13. The system of claim 12 wherein the group list comprises one or more pre-registered subscribers, wherein the subscribers access the tracker server through one or more wireless capable devices.

14. A portable device comprising:
a tracker unit, wherein the tracker unit periodically determines and stores location and identity data of the portable device, wherein the portable device is configured to communicate with a tracker server having a user database via a wireless network, and further wherein the location and identification data is automatically sent from the portable device to the tracker server when the portable device is in communication with the wireless network, wherein the tracker server stores the location and identification data in the user database.

15. The device of claim 14 wherein the portable device further comprises a tracking disable feature that allows the user to prevent the portable device from sending the location data to the tracking server.

16. The device of claim 14 wherein the location and identification data is encrypted to prevent unauthorized access to the data.

17. The device of claim 14 wherein the wireless network comprises one or more WiFi, subscription based or cellular networks.

18. The device of claim 14 wherein the tracker server sorts the location data in the user database based on the identification data.

19. The device of claim 14 wherein the portable device is a camera.

20. The device of claim 14 wherein the location data comprises one or more sets of a longitude, a latitude and a time.

21. The device of claim 20 wherein the portable device is configured to send image data to the tracker server wherein the tracker server stores the image data in the user database based on the identification data.

22. The device of claim 21 wherein the portable device further comprises a display, and wherein the tracker unit displays the location data on the display by indicating one or more positions of the portable device on a map.

23. The device of claim 22 wherein the tracker unit further displays links to the image data on the display such that the image data is able to be displayed on the display by following the links.

24. The device of claim 23 further comprising a user profile database, wherein a user registers user profile information with the tracker server and the tracker server stores the user profile information in the user database based on the identification data.

25. The device of claim 24 wherein the user profile information comprises any combination of a username, a password, a group list and avatar data.

26. The device of claim 25 wherein the group list comprises one or more pre-registered subscribers, wherein the subscribers access the tracker server through one or more wireless capable devices.

27. A method of wirelessly tracking a portable device comprising:
periodically determining and storing location and identification data of a portable device having a tracker unit with the tracker unit; and
automatically sending the location and identification data to a tracker server having a user database when the portable device is in communication with a wireless network, wherein the tracker server stores the location data in the user database.

28. The method of claim 27 wherein the portable device is a camera.

29. The method of claim 27 wherein the portable device further comprises a tracking disable feature that allows the user to prevent the portable device from sending the location data to the tracking server.

30. The method of claim 27 wherein the location and identification data is encrypted to prevent unauthorized access to the data.

31. The method of claim 27 wherein the tracker server sorts the location data in the user database based on the identification data.

32. The method of claim 27 the wireless network comprises one or more WiFi, subscription based or cellular networks.

33. The method of claim 27 wherein the location data comprises one or more sets of a longitude, a latitude and a time.

34. The method of claim 33 further comprising sending image data from the portable device to the tracker server wherein the tracker server stores the image data in the user database based on the identification data.

35. The method of claim 34 wherein the portable device further comprises a display, and the method further comprises displaying the location data on the display by indicating one or more positions of the portable device on a map.

36. The method of claim 35 further comprising displaying links to the image data on the display such that the image data is able to be displayed on the display by following the links.

37. The method of claim 36 further comprising registering user profile information with the tracker server and the tracker server storing the user profile information in the user database based on the identification data.

38. The method of claim 37 wherein the user profile information comprises any combination of a username, a password, a group list and avatar data.

39. The method of claim 38 wherein the group list comprises one or more pre-registered subscribers, wherein the subscribers access the tracker server through one or more wireless capable devices.

40. A tracker server comprising:
a user database, wherein the tracker server is configured to communicate with a portable device having a tracker unit, wherein the tracker unit periodically determines and stores location and identification data of the portable device, and further wherein the location and identification data is automatically sent from the portable device to the tracker server when the portable device is in communication with a wireless network and the tracker server stores the location and identification data in the user database, wherein the portable device is in communication with the tracker server via the wireless network.

41. The server of claim 40 wherein the portable device is a camera.

42. The server of claim 40 wherein the portable device further comprises a tracking disable feature that allows the user to prevent the portable device from sending the location data to the tracking server.

43. The server of claim 40 wherein the location and identification data is encrypted to prevent unauthorized access to the data.

44. The server of claim 40 wherein the wireless network comprises one or more WiFi, subscription based or cellular networks.

45. The server of claim 40 wherein the tracker server sorts the location data in the user database based on the identification data.

46. The server of claim 40 wherein the location data comprises one or more sets of a longitude, a latitude and a time.

47. The server of claim 46 wherein the portable device is configured to send image data to the tracker server wherein the tracker server stores the image data in the user database based on the identification data.

48. The server of claim 47 wherein the portable device further comprises a display, and wherein the tracker unit displays the location data on the display by indicating one or more positions of the portable device on a map.

49. The server of claim 48 wherein the tracker unit further displays links to the image data on the display such that the image data is able to be displayed on the display by following the links.

50. The server of claim 49 further comprising a user profile database, wherein a user registers user profile information with the tracker server and the tracker server stores the user profile information in the user database based on the identification data.

51. The server of claim 50 wherein the user profile information comprises any combination of a username, a password, a group list and avatar data.

52. The server of claim 51 wherein the group list comprises one or more pre-registered subscribers, wherein the subscribers access the tracker server through one or more wireless capable devices.
